(19) United States
(12) Patent Application Publication
(10) Pub. No.: US 2006/0020506 A1
(43) Pub. Date: Jan. 26, 2006

(54) Adjusting or determining ad count and/or ad branding using factors that affect end user ad quality perception, such as document performance

(76) Inventors: Brian Axe, San Francisco, CA (US); Alexander Paul Carobus, Mountain View, CA (US); Deepak Jindal, Mountain View, CA (US); Lawrence E. Page, Palo Alto, CA (US); Gokul Rajaram, Mountain View, CA (US)

Correspondence Address: STRAUB & POKOTYLO, 620 TINTON AVENUE, BLDG. B, 2ND FLOOR, TINTON FALLS, NJ, 07724, US

(21) Appl. No.: 10/895,026

(22) Filed: Jul. 20, 2004

(51) Int. Cl. G06Q 30/00

(52) U.S. Cl. 705/14

(57) ABSTRACT

Documents or document sets may be scored to reflect a value of an action, such as a selection for example, when an ad is served with the document (or a document belonging to a document set). A number of ads to be served with a document, and/or a type or level of branding to be provided to such ads, may then be controlled using the score. Document scores used in this way may help the ad serving system maintain and manage the quality of its brand. Further, a number of ads to be served, and/or a type or level of branding to be provided to such ads may be controlled using other factors that may affect end user perceptions of the quality of ads.

### 1. BACKGROUND OF THE INVENTION

1.1 Field of the Invention

The present invention concerns advertisements (“ads”), such as ads served in an online environment. In particular, the present invention concerns techniques that can be used to manage ad quality, or end user perceptions of ad quality, and ad quality branding.

1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.) Query keyword-relevant advertising has been used by search engines. The AdWords advertising system by Google of Mountain View, Calif. is one example of query keyword-relevant advertising. Similarly, content-relevant advertising systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content-relevant advertising, such as the AdSense advertising system by Google, has been used to serve ads on Web pages.

Some ad delivery systems (e.g. DoubleClick) dynamically select ads with the highest price per Web page view. Other ad delivery systems (e.g. Overture) are pay per performance based and simply select ads with the highest price per click. Most content Website ad delivery systems (e.g. DoubleClick) show an ad in every slot on a Web page to maximize the revenue of the Web page view. Sadly, this focus on maximizing Web page view revenue often comes at the expense of end users being inundated with too many ads, often of marginal or no value to the end user. Furthermore, some content ad systems target ads to users of a given Website, but do not target ads to a specific topic on a Webpage. Ads from such content ad delivery systems that employ crude and rudimentary targeting are often of marginal or no value to the end user. Worse yet, some advertisers, such as eBay for example, place ads that are purely static, with no content matching.

Consequently, end users can become conditioned to ignore ads from such ad delivery systems. Moreover, since such ads often have exactly the same look, or at least a confusingly similar look, as ads served by more sophisticated and discriminating ad delivery systems such as the AdSense content-relevant ad system from Google, end users can become conditioned to ignore more relevant, useful ads.

In addition, even with more sophisticated and discriminating ad delivery systems such as the AdSense content-relevant ad system from Google, the performance of ads (e.g., as derived from some indicator(s) of usefulness to end users, such as selections, conversions, etc.) may vary depending on the document (e.g., Web page) with which the ads are rendered. Thus, even if end users were able to discriminate ads delivered by a better ad delivery system, from ads of other ad delivery systems, if the usefulness of ads of the better ad delivery system varies across different documents, ads found to be less useful on poorer performing documents might condition users to ignore more useful ads on better performing documents.

In view of the foregoing, it would be useful for better ad delivery systems to maintain a good perception of its ads by end users and to avoid tarnishing such a good perception due to ads with the same or similar format by other ad delivery systems, and/or due to its own ads on poorly performing documents.

### 2. SUMMARY OF THE INVENTION

At least some embodiments consistent with the present invention may be used to control (e.g., adjust or determine) the number of ads rendered, and/or a type and/or degree of branding associated with ads, using one or more factors that affect end user perception of the ads.

In at least some embodiments consistent with the present invention, such factors may include some measure of the performance of the document (e.g., a Web page) on which the ads will be rendered. In at least some embodiments consistent with the present invention, such factors may include some degree of confidence in the targeting used (e.g., some degree of similarity, type of targeting used, etc).

### 3. BRIEF DESCRIPTION OF THE DRAWINGS

FIG. 1 is a high-level diagram showing parties or entities that can interact with an advertising system.

FIG. 2 is a diagram illustrating an environment in which, or with which, embodiments consistent with the present invention may operate.

FIG. 3 is a bubble diagram of operations and information for scoring documents in a manner consistent with the present invention.

FIG. 4 is a bubble diagram of operations and information for adjusting ad number and/or ad branding using factors that may affect end user perceptions of ad quality, such as document scores, in a manner consistent with the present invention.

FIG. 5 is a flow diagram of an exemplary method for performing a document scoring operation in a manner consistent with the present invention.

FIG. 6 is a flow diagram of an exemplary method for determining an ad score, which may be used in the scoring of a document, in a manner consistent with the present invention.

FIG. 7 is a flow diagram of exemplary method for controlling a number of ads to be served with a document, in a manner consistent with the present invention.

FIG. 8 is a flow diagram of exemplary method for controlling a type and/or degree of branding to be associated with served ads, in a manner consistent with the present invention.

FIG. 9 is a block diagram of an exemplary apparatus that may perform various operations and store various information in a manner consistent with the present invention.

FIGS. 10-19 show examples of different ad spot formats having different levels of ad branding, to be rendered in a top or bottom margin of a Web page.

FIGS. 20-24 show examples of different ad spot formats having different levels of ad branding, to be rendered in a right or left margin of a Web page.

FIGS. 25-35 show examples of different ad spot formats having different levels of ad branding, to be rendered in a top or bottom margin of a Web page.

FIGS. 36-42 show examples of different ad spot formats having different levels of ad branding for ads to be rendered with a Web page.

FIGS. 43A-43K show various ad formats, all with “Ads by Goooooooooooogle” text, for various ad spots of various dimensions.

### 4. DETAILED DESCRIPTION

The present invention may involve novel methods, apparatus, message formats, and/or data structures for scoring documents or document groups, and/or using such a score of a document or document group, and/or some other factor of end user perception of ad quality, to control a number of ads to served with the document or with a document of the document group, and/or to control a type and/or level of branding to be used with such ads. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

In the following, definitions that may be used in this description are provided in § 4.1. Then, environments in which, or with which, the present invention may operate are described in § 4.2. Thereafter, exemplary embodiments consistent with the present invention are described in § 4.3. Then, some illustrative examples are provided in § 4.4. Finally, some conclusions regarding the present invention are set forth in § 4.5.

4.1 Definitions

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served; one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, a type of targeting used (e.g., concept (which may include the specific type of concept targeting used), broad keyword, exact keyword, phrase keyword, etc.), a degree of relevancy of ad, a quality metric of a publisher of the document with which the ad was served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Conversions can also be tracked with different levels of granularity (e.g., number of items purchased, classes of items or services purchased, total purchase cost, limited to one conversion per selection in a conservative case, etc.) Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions or selections of the ad (i.e., the number of times an ad is rendered or selected) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has a unique, addressable, storage location and can therefore be uniquely identified by this addressable location. A universal resource locator (URL) is a unique address used to access information on the Internet (though instances of information may often be replicated and stored at multiple locations).

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, etc.), a media player (e.g., an MP3 player, a Realnetworks streaming audio or video file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server (e.g., a Web publisher) might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

“Ad area” may be used to describe an area (e.g., spatial and/or temporal) of a document reserved or made available to accommodate the rendering of ads. For example, Web pages often allocate a number of spots where ads can be rendered, referred to as “ad spots”. An ad spot may be able to accommodate one or more ads. As another example, an audio program may allocate “ad time slots”.

A “graphical element” may include, but is not limited to, a portable network graphics (PNG) element, a joint photographic experts group (JPEG) element, a graphics interchange format (GIF) element, a scalable vector graphics (SVG) element, a tagged image file format (TIFF) element, a bitmap, etc.

4.2 Environments in Which, or with Which, the Present Invention may Operate

4.2.1 Exemplary Advertising Environment

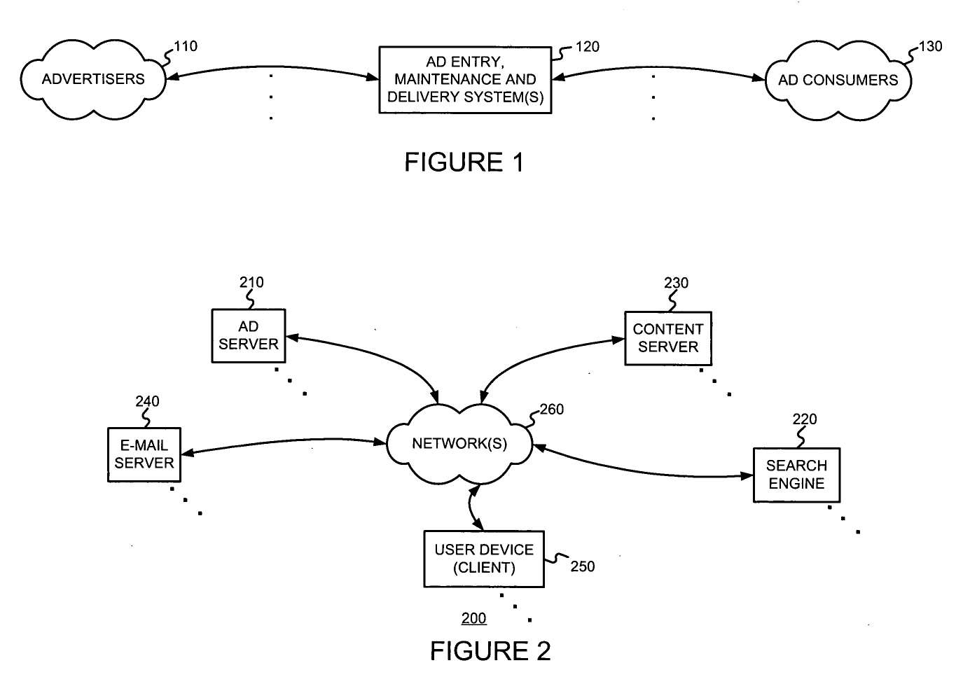

FIG. 1 is a high level diagram of an advertising environment. The environment may include an ad entry, maintenance and delivery system (simply referred to as an “ad server” or “ad system”) 120. Advertisers 110 may directly, or indirectly, enter, maintain, and track ad information in the system 120. The ads may be in the form of graphical ads such as so-called banner ads, text-only ads, image ads, audio ads, animation ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or a selection related to the ad occurred) to the system 120. This usage information may include measured or observed user behavior related to ads that have been served.

The ad server 120 may be similar to the one described in FIG. 2 of the '900 application. The ad server 120 may store different advertising programs from different advertisers. An advertising program may include information concerning accounts, campaigns, creatives, targeting, etc. The term “account” relates to information for a given advertiser (e.g., a unique e-mail address, a password, billing information, etc.). A “campaign” or “ad campaign” may be used to refer to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, geolocation information, user profile information, etc.), and price information (e.g., a maximum cost or offer per selection, a maximum cost or offer per conversion, a cost or offer per selection, a cost or offer per conversion, etc.). Alternatively, or in addition, each ad group may include an average cost (e.g., average cost per selection, average cost per conversion, etc.). Therefore, a single maximum cost, cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or service). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, etc.), some other content rendering facility, an e-mail facility (e.g., Outlook from Microsoft), etc. A search engine 220 may permit user devices 250 to search collections of documents (e.g., Web pages). A content server 210 may permit user devices 250 to access documents. An e-mail server (such as Gmail from Google, Hotmail from Microsoft Network, Yahoo Mail, etc.) 240 may be used to provide e-mail functionality to user devices 250. An ad server 210 may be used to serve ads to user devices 250. For example, the ads may be served in association with search results provided by the search engine 220. Alternatively, or in addition, content-relevant ads may be served in association with content provided by the content server 230, and/or e-mail supported by the e-mail server 240 and/or user device e-mail facilities.

As discussed in the '900 application (introduced above), ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., a Web page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number (e.g., ten) of search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate, and/or as described below, information related to, and/or derived from, the search query), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

The search engine 220 may transmit information about the ad and when, where, and/or how the ad was to be rendered (e.g., position, click-through or not, impression time, impression date, size, conversion or not, etc.) back to the ad server 120/210. As described below, such information may include information for determining on what basis the ad was determined relevant (e.g., strict or relaxed match, or exact, phrase, or broad match, etc.) Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

4.3 Exemplary Embodiments

Embodiments consistent with the present invention may be used to help ad delivery systems to maintain a good perception of its ads by end users and to avoid tarnishing such a good perception due to ads with the same or similar format by other ad delivery systems, and/or due to its own ads being rendered with poorly performing documents or being served under circumstances that might decrease their usefulness to end users. The present invention may do so by controlling the number of ads rendered, and/or a type and/or degree of branding associated with ads, using one or more factors that affect end user perception of the ads. Such factors may include some measure of the performance of the document (e.g., a Web page) on which the ads will be rendered, some degree of confidence in the targeting (e.g., some degree of similarity, type of targeting used, etc), etc.

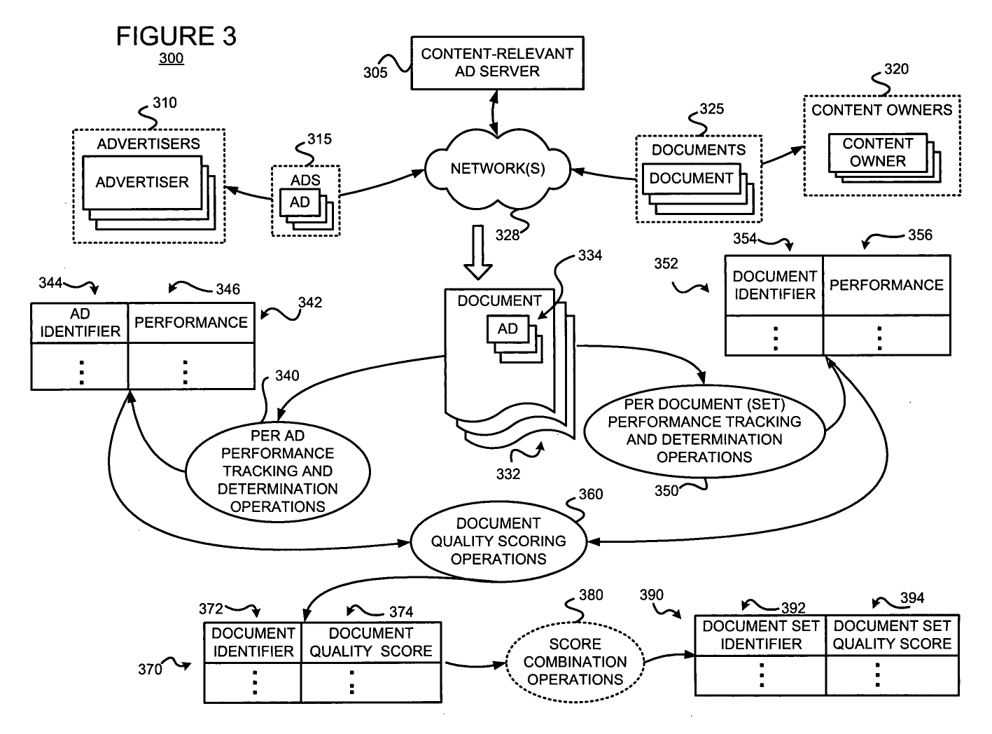

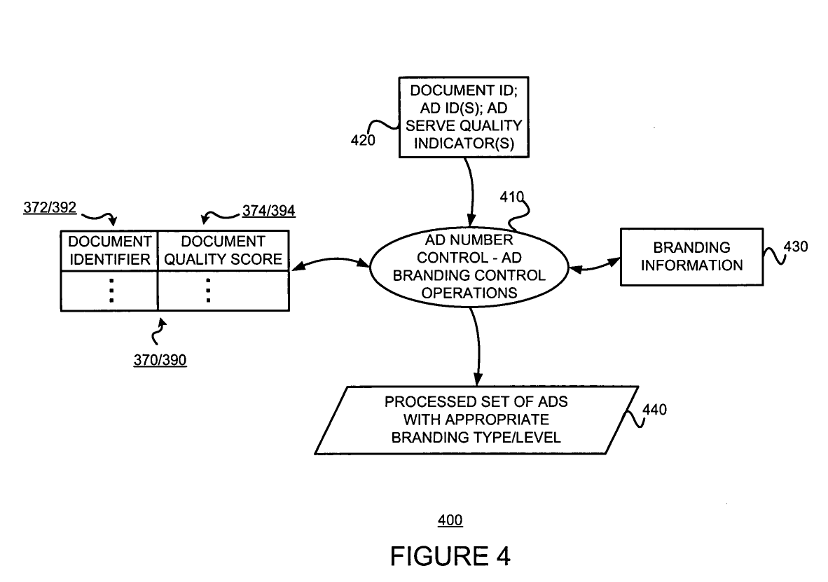

FIG. 3 is a bubble diagram of operations and information for scoring documents (or document sets) in a manner consistent with the present invention. FIG. 4 shows how document quality scores, such as those determined as described with reference to FIG. 3 for example, may be used to help ad delivery systems maintain a good perception of its ads by end users and avoid tarnishing such a good perception due to ads with the same or similar format by other ad delivery systems, and/or due to its own ads being rendered with poorly performing documents.

4.3.1 Determining Document Quality Scores

Although embodiments consistent with the present invention can be used with various types of document quality scores, even including manually determined document quality scores or scores provided from a third party source, this section describes various techniques that may be used to determine document quality scores. The same or similar techniques are described in U.S. patent application Ser. No. 10/880,972 (incorporated herein by reference, and referred to as “the '972 application”), titled “ADJUSTING AD COSTS USING DOCUMENT PERFORMANCE OR DOCUMENT COLLECTION PERFORMANCE,” filed on Jun. 30, 2004, and listing Brian Axe, Doug Beeferman, Amit Patel, Nathan Stoll and Hal Varian as inventors.

FIG. 3 is a bubble diagram of operations and information for scoring documents (or document sets) in a manner consistent with the present invention. As shown, a content-relevant ad server 305 may interact with advertisers 310 and content owners (e.g., content servers) 320 via one or more networks 328, such as the Internet for example. More specifically, the content-relevant ad server 305 may be used to deliver ads 315 from the advertisers 310 with documents (e.g., Web pages) 325 from content owners 320. Although not shown in FIG. 3, other ad servers may serve ads with other documents, such as search result pages for example.

As documents 332 with ads 334 are served, various performances may be tracked. For example, per ad performance tracking and determination operations 340 may be used to generate ad performance information 342. The ad performance information 342 may include a number of entries, and each entry may include an ad identifier 344 and one or more performance values 346. The one or more performance values 346 may be selection rates, conversion rates, user ratings, etc., over some collection of documents (e.g., across all documents with which the ad was served). As another example, per document (set) performance tracking and determination operations 350 may be used to generate document performance information 352. The document performance information 352 may include a number of entries, and each entry may include a document identifier (e.g., a URL of a Web page) 354, and one or more performance values 356. The one or more performance values 356 may be selection rates, conversion rates, user ratings, etc., over some collection of ads (e.g., across all ads that were served with the document).

The document performance values 356 could be used, without further processing, in the context of the present invention. However, for a given document, a better document performance value might be discovered if the influence of the performance of ads that the document has shown was removed. This may be done as follows. Document quality scoring operations 360 may use ad performance information 342 and/or document performance information 352 to generate document score information 370. As shown, the document score information 370 may include a number of entries, and each entry may include a document identifier 372 and a document quality score 374. In at least some embodiments consistent with the present invention, score combination operations 380 may be used to generate document set score information 390. As shown, the document set score information 390 may include a number of entries, and each entry may include a document set identifier 392 and a quality score 394 for the document set. Although not shown, a mapping of document identifiers to document set identifiers may also be stored.

The document scores may be used to indicate an expected performance (e.g., selection rate, conversion rate, etc.) for the document over a collection of ads (e.g., all ads). Similarly, the document set scores may be used to indicate an expected performance for the document set over a collection of ads (e.g., all ads). As will be described in § 4.3.2 below, such scores can be used to help ad delivery systems maintain a good perception of its ads by end users and avoid tarnishing such a good perception due to ads with the same or similar format by other ad delivery systems, and/or due to its own ads being served with poorly performing documents.

4.3.2 Adjusting AD Number and/or AD Branding Level/Type Using One or More Factors that Affect End User Perception of the Ads, Such as Document Quality Scores

FIG. 4 is a bubble diagram of operations and information for using document scores to control a number of ads served with a document, and/or to control a type or level of ad branding in a manner consistent with the present invention. As shown, ad number control and/or ad branding control operations 410 may accept an identifier of a document (or document set) with which (e.g., on which) the ads are to be served 420. The information 420 may also include identifiers of one or more ads to be served with the document, and/or one or more ad serve quality indicators. The operations 410 may use document quality score information 370/390 to control a number of ads served and/or to control a branding type and/or level. More specifically, the operations 410 may use the document identifier included with information 420 to lookup a document (or document set) quality score in the document score information 370/390. The operations 410 may then use the document (or document set) quality score to control (e.g., determine or adjust) a number of ads to be served with the document. Alternatively, or in addition, the operations 410 may then use the document (or document set) quality score to determine a type, and/or level of branding to be used with the ads. For example, the operations 410 may use branding information 430. A processed set of ads with an appropriate branding type and/or level 440 may be generated in this way.

Although the document (or document set) quality score may be one factor affecting an end user perception of the quality of the ads, one or more other factors may be used instead of, or in addition to, document (or document set) quality. For example, the performance of an ad itself, or some combined performance of a set of ads, may be such a factor. As another example, various ad serve quality indicators may be factors. More specifically, in the context of content-relevant ad serving, a degree of similarity between the ad and the document, and/or a confidence level in such a degree of similarity (or some other relevancy score), may be such a factor. A content score, which rates whether the content-relevant ad server can determine what specific topic the Web page, or area of the Web page, is about with an appropriate level of certainty, may be another factor. In the context of keyword-targeted ad serving, a type of keyword targeting used (e.g., broad, phrase, exact) may be such a factor. As yet another example, user behavior may be such a factor. For example, if a user selects a certain type of ad (or converts on, or remains at the ad landing page for a certain amount of time), then more of that same ad may be shown, perhaps with enhanced branding, especially when the user navigates or views content related to the ad(s) selected.

At least some of the foregoing embodiments tracked some performance of documents, scored the documents using the tracked value, and determined a number of ads to serve and/or a type or level of branding to provide using the scores. In at least some embodiments consistent with the present invention, the performance of documents can be tracked with finer granularity. For example, the performance of a document per ad can be tracked, the performance of the document per ad collection (e.g., text ads, image ads, video ads, audio ads, ads from a given advertiser, etc.) can be tracked, the performance of the document per targeting criteria (e.g., per keyword, per keyword collection, per geolocation, per time, per date, per season, per month, per day of week, per user type, per user behavior, etc.) can be tracked, the performance of the document per targeting technique (e.g., keyword targeted, content targeted, etc.), the performance of the document per query match type can be tracked (e.g., exact, phrase, broad, etc.), etc. This tracked information may be used in determining more specific per document scores. Such more specific document scores can be selectively used, perhaps along with other factors, to determine a number of ads to serve and/or a type or level of branding to provide using the scores.

As one example, consider an embodiment consistent with the present invention in which ad-specific document scores S(docᵢ, adⱼ) could be used directly (if there was enough data). In such an alternative embodiment, the branding applied to different ads might be different.

As an example of determining a branding type depending on the performance of the type of targeting used, suppose the keyword “diamond” delivers ads with a better end user quality perception (as inferred from a higher conversion rate) when the ad is targeted to search than when it is targeted to content. This fact could be used to apply a lower level of branding to ads targeted to content using the concept “diamond.” As another example, suppose that the keyword “diamond” converts much better via exact match (search query contains only that keyword) than broad match (search query contains any of the keywords or synonyms of the keyword). This fact could be used to apply a higher level of branding to ads using diamond with exact matching than to ads using diamond with broad matching. There may also be different types of content-targeting which could have different affects on end user quality perceptions (e.g., URL-based where the entire Webpage is crawled versus content extraction where javascript sends key pieces of the Webpage versus publisher specified keywords used as hints along with the page contents versus publisher specified keywords and no page content).

A publisher quality metric (which may be a function of one or more of the use of pop-up ads, search index spamming techniques like invisible text, suspect fraudulent activity like clicking on ads or forging conversions, etc.) may also be a factor in end user quality perceptions.

4.3.3 Exemplary Data Structures

Data structures, such as 342, 352, 370 and 390 of FIGS. 3 and 420 and 430 of FIG. 4 for example, may be used to store information generated and/or used in a manner consistent with the present invention.

4.3.4 Exemplary Methods

As introduced above, embodiments consistent with the present invention may be used to score documents, or sets of documents, typically using some measure of value of an action or user action triggering a cost to an advertiser. Exemplary methods that may be used to score documents, in a manner consistent with the present invention, are described in § 4.3.4.1 below.

As also introduced above, embodiments consistent with the present invention may be used to control a number of ads to be served with a document, and/or to control a level and/or type of branding to be used with such ads, using one or more factors affecting end user quality perception, such as a determined document quality score for example. Exemplary methods that may be used to provide such control, in a manner consistent with the present invention, are described in § 4.3.4.2 below.

4.3.4.1 Exemplary Methods for Determining Document Scores

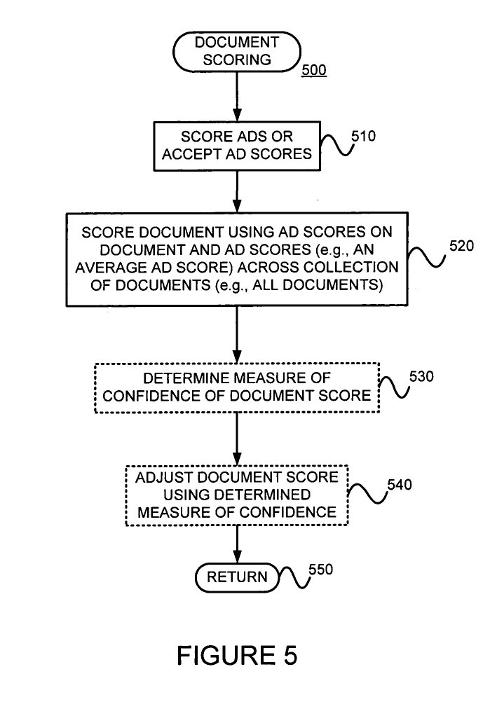

FIG. 5 is a flow diagram of an exemplary method 500 for scoring a document in a manner consistent with the present invention. Ad scores are determined or accepted. (Block 510) The document is then scored using ad scores on the document, and scores of the ads across a collection of documents (e.g., all documents). (Block 520) The method 500 may then be left. (Node 550) As shown, a measure of confidence in the determined document score may be determined (Block 530) and used to adjust the document score (Block 540).

Recall from block 510 of FIG. 5 that ad scores are accepted or determined. In at least one embodiment consistent with the present invention, the ad scores are ad return on investment (ROI) scores, which may be determined as described in the '972 application introduced above. Alternatively, or in addition, the ad scores may reflect ad selection rate, ad conversion rate, etc.

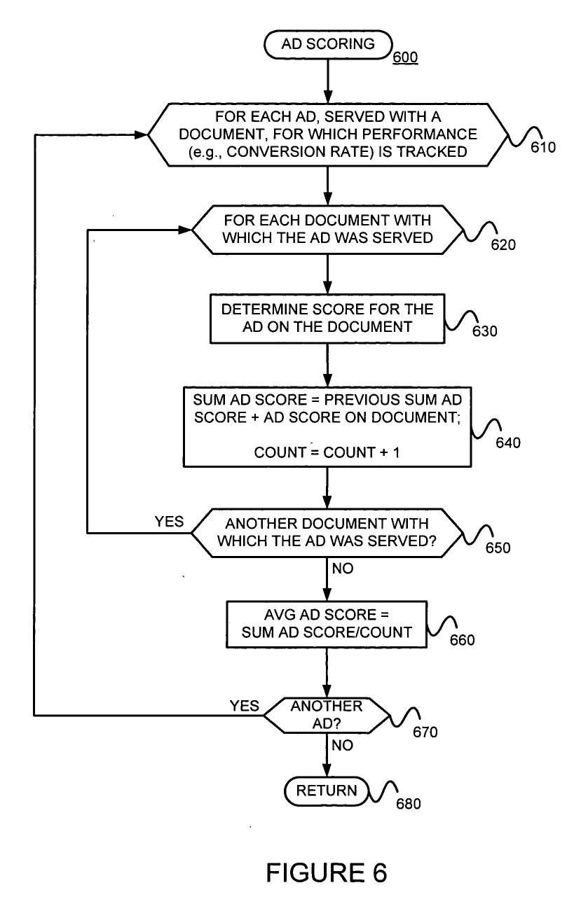

FIG. 6 is a flow diagram of an exemplary method 600 for performing ad scoring operations in a manner consistent with the present invention. As indicated by loop 610-670, a number of acts are performed for each ad served with a document for which performance (e.g., a conversion rate) is tracked. Further, as indicated by nested loop 620-650, a number of acts are performed for each document with which the ad was served. The score for the ad (or advertiser) on the document is determined. (Block 630) A score sum for the ad (or advertiser) is maintained, as is a count of the number of documents. (Block 640). After all of the documents have been considered, a score for the ad over all documents is determined. (Block 660) For example, the score may be an average score defined by the score sum divided by the count. The score may be some other combination of scores. Further ads may then be processed before the method 600 is left. (Node 680)

The score of an ad on a document may be determined in various ways. For example, a selection rate may be tracked and used. Alternatively, or in addition, ad ROI may be tracked and used. Alternatively, or in addition, ad conversion rate may be tracked and used.

4.3.2.2 Exemplary Methods for Controlling a Number of Ads to be Served with a Document, and/or Branding Associated with ads to be Served with a Document

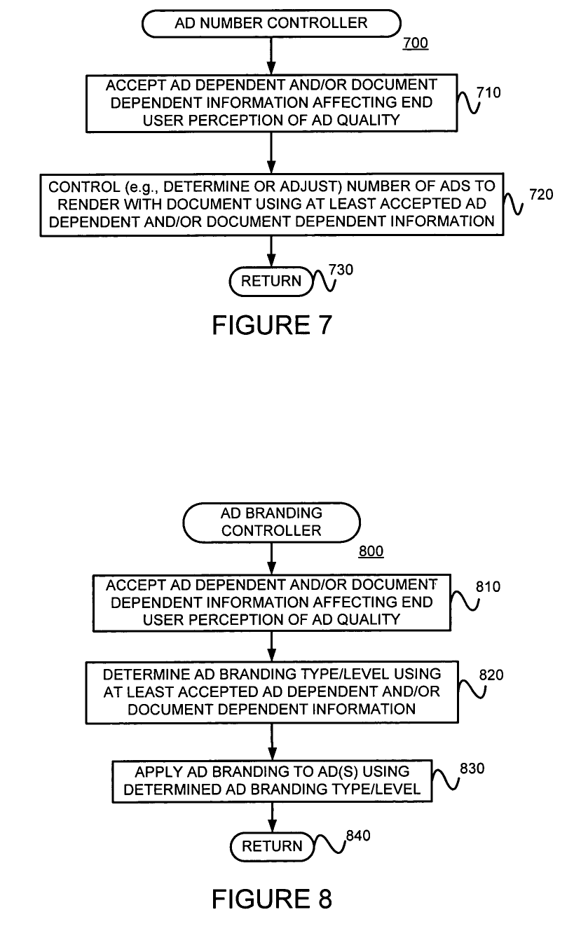

FIG. 7 is a flow diagram of exemplary method 700 for controlling a number of ads to be served with a document, in a manner consistent with the present invention. Document dependent (and/or ad dependent) information affecting end user perception of ad quality is accepted. (Block 710) A number of ads to render with the document is then controlled (e.g., determined or adjusted) using at least the accepted ad dependent and/or document dependent information. (Block 720) Controlling the number of ads to be served with the document may involve adjusting an initial number, or directly determining a number. The method 700 is then left (Node 730).

FIG. 8 is a flow diagram of exemplary method 800 for controlling a type and/or degree of branding to be associated with served ads, in a manner consistent with the present invention. Document dependent (and/or ad dependent) information affecting end user perception of ad quality is accepted. (Block 810) A level and/or type of ad branding is then determined using at least the accepted ad dependent and/or document dependent information. (Block 820) Then, ad branding is applied to the ad(s) using the determined level and/or type (Block 830) before the method 800 is left (Node 840).

In the context of a system, such as system 200 of FIG. 2, one exemplary implementation consistent with the present invention may operate as follows. First, Javascript in a transparent iframe on a publisher's Web page, which calls the content-relevant ad system, writes a global variable (e.g. skip=<N>) after discovering other slots on the same Web page. A “global variable” is a variable that is accessible to the javascript executing on all of the adslots of the Webpage. For example, assuming that a publisher has defined three (3) adslots on its Webpage, the first adslot may initialize the global variable (e.g., set “ad slot” to 0 since “ad slot” is not yet defined. The other adslots may then determine if “ad slot” is defined, and if it is, the other adslots may increment it by 1. Since “ad slot” is a global variable (i.e., not confined to a single adslot), all adslots have access to the same variable. Thus, the global variable “ad slot” can be used to help determine how many adslots are on the Webpage. The javascript for each may increment this global variable to let the ad system know how many ads to return for each slot (e.g. slot 1 pulls ads 1-3, slot 2 pulls ads 4-9, slot 3 pulls ads 10-11). The ad system can determine a single set of ads (ads 1-11) for all of the ad slots. Alternatively, the ad system can determine separate sets of ads for each of the slots, while preferably tracking the ads shown to each slot to avoid showing duplicate ads on the page view.

In at least one embodiment consistent with the invention, for low scoring Web pages (e.g., those with low predicted selection rates), any slot beyond the first slot does not show any ads. This may be done by having the ad system not send any html to be displayed in the transparent iframe, or by having the ad system send a background color (e.g., a custom color specified by the publisher). Alternatively, some publishers may be configured to have a publisher specified alternative ad (which may be managed and/or inserted by the publisher) show which will appear in the additional slots instead of making the slots blank.

On the other hand, for high scoring Web pages (e.g., those with high predicted selection rates), all slots may be filled with ads. Further, eye-catching ad formats (e.g., including a brand icon, brand colors, etc.) may be used to more strongly associate the brand of the ad server with the displayed ads.

For requests coming from browsers which do not support transparent iframes (e.g. Netscape), the ad serving system may detect the browser in the header of the request and send back html setting the iframe window to the same background color as the parent window.

4.3.5 Exemplary Apparatus

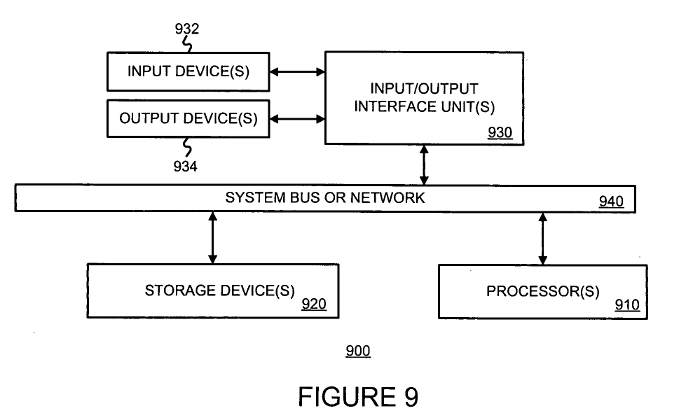

FIG. 9 is high-level block diagram of a machine 900 that may perform one or more of the operations discussed above. The machine 900 basically includes one or more processors 910, one or more input/output interface units 930, one or more storage devices 920, and one or more system buses and/or networks 940 for facilitating the communication of information among the coupled elements. One or more input devices 932 and one or more output devices 934 may be coupled with the one or more input/output interfaces 930.

The one or more processors 910 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 920 and/or may be received from an external source via one or more input interface units 930.

In one embodiment, the machine 900 may be one or more conventional personal computers. In this case, the processing units 910 may be one or more microprocessors. The bus 940 may include a system bus. The storage devices 920 may include system memory, such as read only memory (ROM) and/or random access memory (RAM). The storage devices 920 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 932, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 910 through an appropriate interface 930 coupled to the system bus 940. The output devices 934 may include a monitor or other type of display device, which may also be connected to the system bus 940 via an appropriate interface. In addition to (or instead of) the monitor, the personal computer may include other (peripheral) output devices (not shown), such as speakers and printers for example.

The various operations described above may be performed by one or more machines 900, and the various information described above may be stored on one or more machines 900. The ad server 210, search engine 220, content server 230, e-mail server 240, and/or user device 250 may include one or more machines 800.

4.3.6 Exemplary Ad Formats with Various Types and/or Levels of Ad Branding

FIGS. 10-19 show examples of different ad spot formats with different branding, such as formats for four horizontally arranged ads to be rendered in a top or bottom margin of a Web page. FIGS. 20-24 show examples of different ad spot formats with different branding, such as formats for four vertically arranged ads to be rendered in a right or left margin of a Web page. FIGS. 25-35 show examples of different ad spot formats with different branding, such as formats for two horizontally arranged ads to be rendered in a top or bottom margin of a Web page. FIGS. 36-42 show examples of different ad spot formats with different branding for vertically arranged ads to be rendered with a Web page. Some of the examples show ad spot formats including brand colors associated with the ad server. Some of the examples show ad formats including an icon or design element, such as a design trademark for example, associated with the ad server.

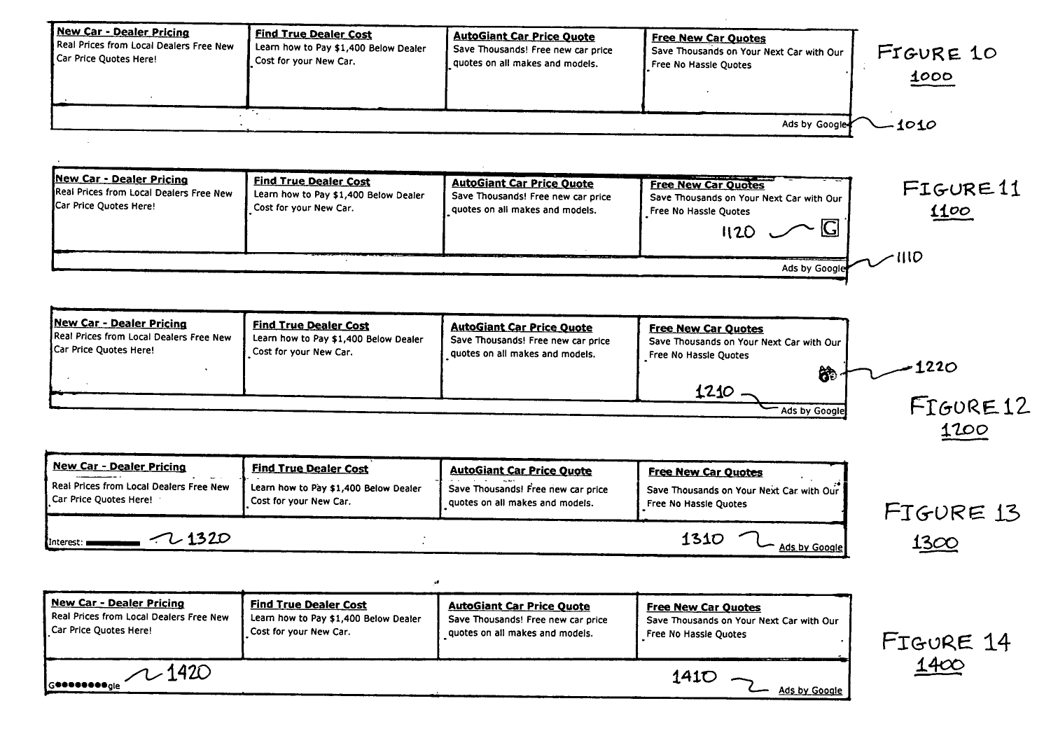

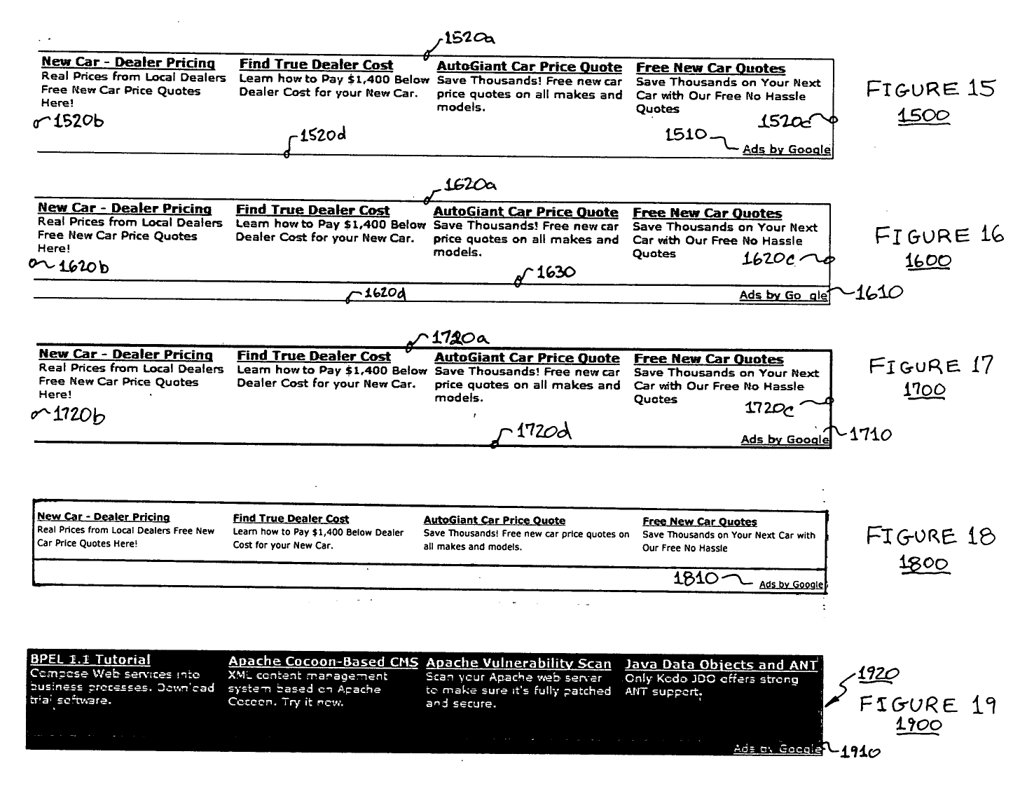

As shown in FIG. 10, a spot filled with ad format 1000 includes four ads and “Ads by Google” text 1010. The characters of the word “Google” are provided with blue, red, yellow and green Google brand colors. This text may be a hypertext link to further information about the ads, such as how the ads are determined, the source of the ads, etc. As shown in FIG. 11, a spot filled with ad format 1100 includes four ads, “Ads by Google” text 1110 and a “G box” brand design element 1120. As shown in FIG. 12, a spot filled with ad format 1200 includes four ads, “Ads by Google” text 1210 and a “googly-eyed binocular” brand design element 1220. As shown in FIG. 13, a spot filled with ad format 1300 includes four ads, “Ads by Google” text 1310 and an interest meter element 1320. As shown in FIG. 14, a spot filled with ad format 1400 includes four ads, “Ads by Google” text 1410 and “Goooooooogle” brand element 1420. As shown in FIG. 15, a spot filled with ad format 1500 includes four ads, “Ads by Google” text 1510 and a box surrounding the ads. Different segments 1520 of the box are provided with blue, red, yellow and green Google brand colors. As shown in FIG. 16, a spot filled with ad format 1600 includes four ads, “Ads by Google” text 1610 and a box surrounding the ads with different segments 1620. In this example 1600, both the box segments 1620 and the characters of the word “Google” are provided with blue, red, yellow and green Google brand colors. Like the colored bars in formats 1000-1500, line 1630 separates the “Ads by Google” text from the ads, thereby helping end users to avoid the mistaken assumption that it is applicable only to the right-most ad. The ad format 1700 of FIG. 17 is similar to that 1500 of FIG. 15, but the colored line segments 1720 of the box are thicker, thereby conveying brand information more prominently. As shown in FIG. 18, a spot filled with ad format 1800 includes four ads and “Ads by Google” text 1810. This format 1800 provides a minimal level of branding. As shown in FIG. 19, a spot filled with ad format 1900 includes four ads, “Ads by Google” text 1910 and large spheres 1920 provided with blue, red, yellow and green Google brand colors. Ad format 1900 provides light (e.g., white) text ads on a dark (e.g., black) background.

As shown in FIG. 20, a spot filled with ad format 2000 includes four ads, “Ads by Google” text 2010 at the top and a “G box” brand design element 2020 at the bottom. As shown in FIG. 21, a spot filled with ad format 2100 includes four ads, “Ads by Google” text 2110 and graphical element 2120 including spheres provided with blue, red, and yellow (and/or green) Google brand colors, both at the top. As shown in FIG. 22, a spot filled with ad format 2200 includes four ads, “Ads by Google” text 2210 and circles provided with blue, red, yellow and green Google brand colors, both at the top. As shown in FIG. 23, a spot filled with ad format 2300 includes four ads, “Ads by Google” text 2310 at the top and large spheres 2320 provided with blue, red, yellow and green Google brand colors at the bottom. Ad format 2300 provides light (e.g., white) text ads on a dark (e.g., black) background. As shown in FIG. 24, a spot filled with ad format 2400 includes four ads and “Ads by Google” text 2410 at the top. This format 2400 provides a minimal level of branding.

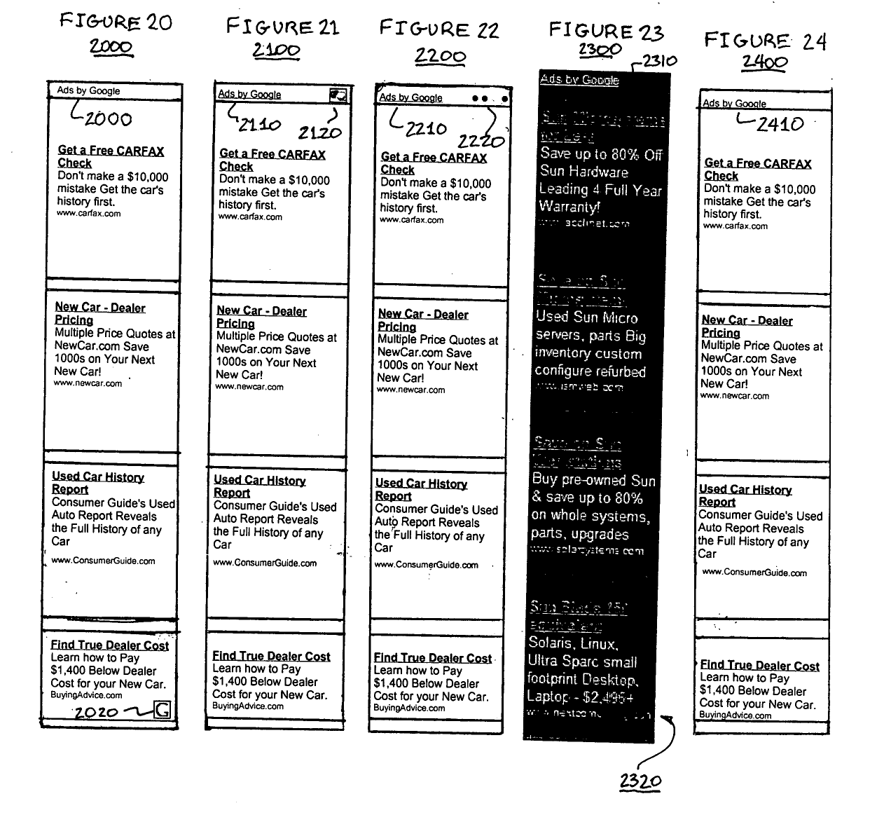

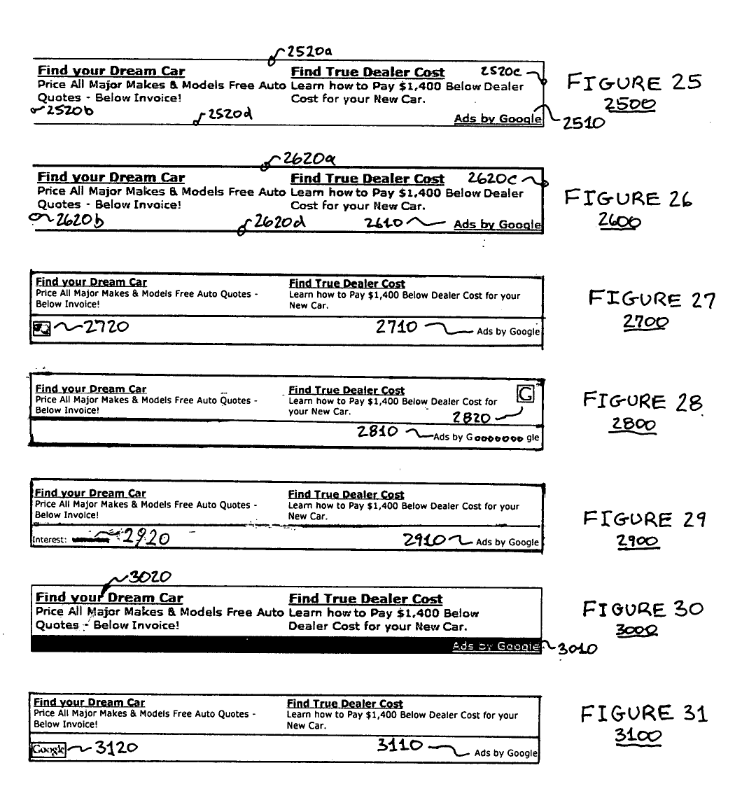

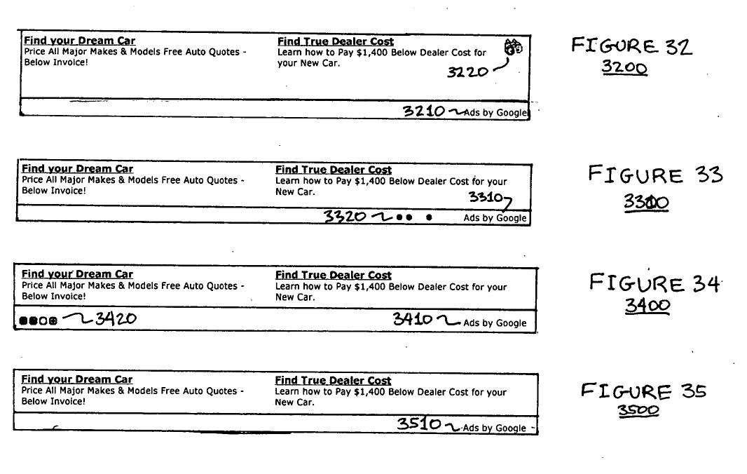

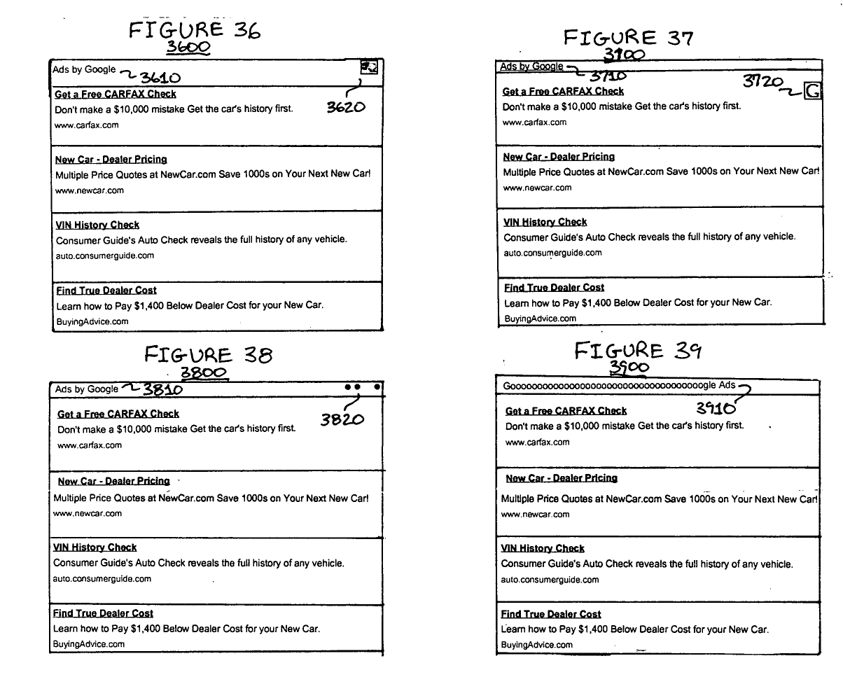

As shown in FIG. 25, a spot filled with ad format 2500 includes two ads, “Ads by Google” text 2510, and a box surrounding the ads with different segments 2520 provided with blue, red, yellow and green Google brand colors. As shown in FIG. 26, a spot filled with ad format 2600 includes two ads, “Ads by Google” text 2610, and a box surrounding the ads with different segments 2620 provided with blue, red, yellow and green Google brand colors. Note that the line segments in 2600 are thicker, and therefore more prominent, than those in 2500. As shown in FIG. 27, a spot filled with ad format 2700 includes two ads, “Ads by Google” text 2710 and a graphical element 2720 including spheres with Google brand yellow, blue and red colors. As shown in FIG. 28, a spot filled with ad format 2800 includes two ads, “Ads by Goooooooogle” text 2810 and a “G box” brand design element 2820. As shown in FIG. 29, a spot filled with ad format 2900 includes two ads, “Ads by Google” text 2910 and an interest meter 2920. As shown in FIG. 30, a spot filled with ad format 3000 includes two ads, “Ads by Google” text 3010 and large, faint spheres 3020 with Google yellow, blue, red and green brand colors. As shown in FIG. 31, a spot filled with ad format 3100 includes two ads, “Ads by Google” text 3110 and “Google” brand element 3120 with blue, red, yellow and green brand colors in the Google brand font. As shown in FIG. 32, a spot filled with ad format 3200 includes two ads, “Ads by Google” text 3210 and a “googly-eyed binocular” brand design element 3220. As shown in FIG. 33, a spot filled with ad format 3300 includes two ads, “Ads by Google” text 3310 and circles provided with blue, red, yellow and green Google brand colors 3320, both at the right. As shown in FIG. 34, a spot filled with ad format 3400 includes two ads, “Ads by Google” text 3410 at the right and circles provided with blue, red, yellow and green Google brand colors 3320 at the left. As shown in FIG. 35, a spot filled with ad format 3500 includes two ads and “Ads by Google” text 3510. This format 3500 provides a minimal level of branding.

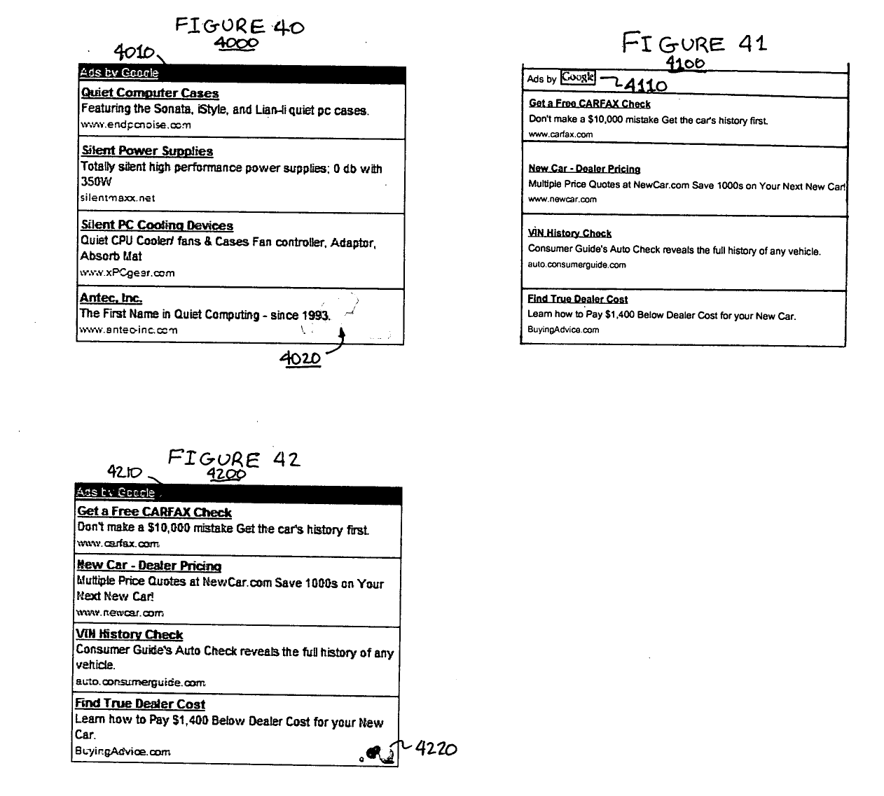

As shown in FIG. 36, a spot filled with ad format 3600 includes four ads, “Ads by Google” text 3610 and a graphical element 3620 including spheres with Google brand yellow, blue and red colors, both at the top. As shown in FIG. 37, a spot filled with ad format 3700 includes four ads, “Ads by Google” text 3710 and a “G box” brand design element 3720, both at the top. As shown in FIG. 38, a spot filled with ad format 3800 includes four ads, “Ads by Google” text 3810 and circles provided with blue, red, yellow and green Google brand colors 3820, both at the top. As shown in FIG. 39, a spot filled with ad format 3900 includes four ads and “Ads by Goooooooogle Ads” text 3910. This format 3900 provides a minimal level of branding. As shown in FIG. 40, a spot filled with ad format 4000 includes four ads, “Ads by Google” text 4010 and large, faint spheres 4020 with Google yellow, blue, red and green brand colors. As shown in FIG. 41, a spot filled with ad format 4100 includes four ads, “Ads by Google” text 4110 and “Google” brand element 4120 with blue, red, yellow and green brand colors in the Google brand font, both at the top. As shown in FIG. 42, a spot filled with ad format 4200 includes four ads, “Ads by Google” text 4210 and spheres (smaller) 4220 with Google yellow, blue, red and green brand colors.

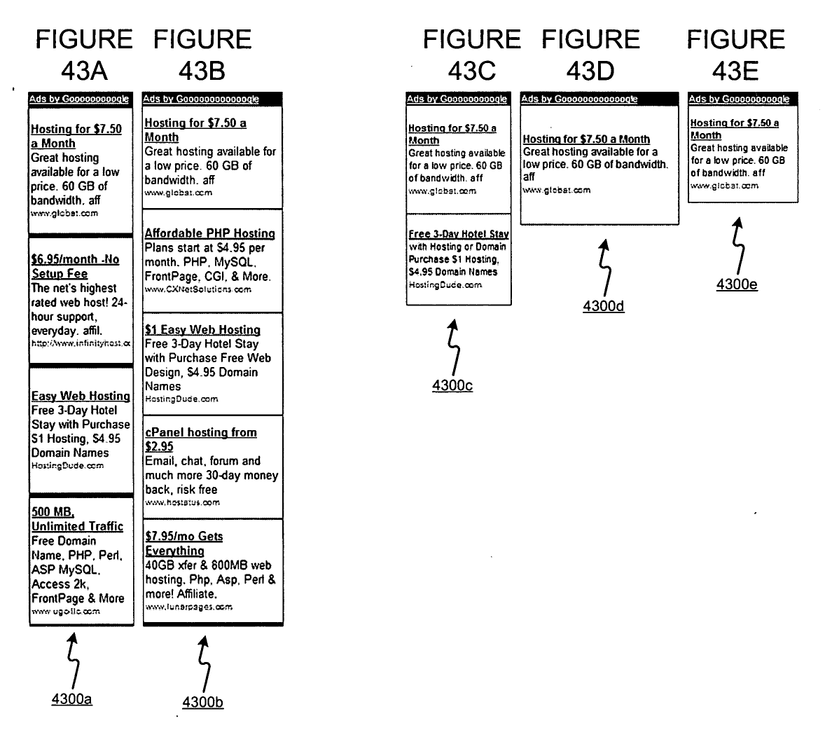

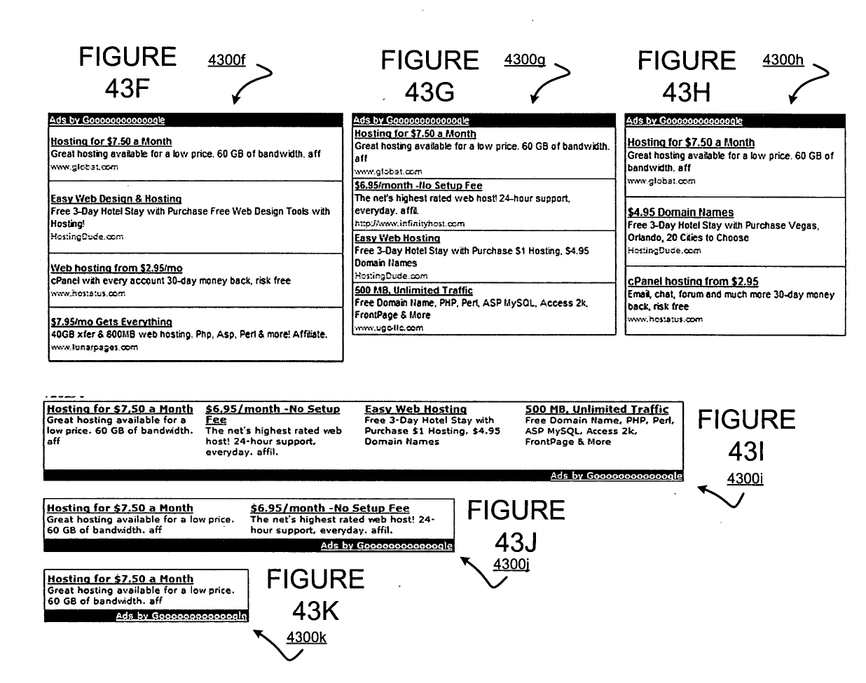

FIGS. 43A-43K show various ad formats, all with “Ads by Goooooooooooogle” text, for various ad spots of various dimensions. Each of the ad formats has light (e.g., white) “Ads by Goooooooooooogle” text in a darker (e.g., blue grey) bar. The creative text of each ad may include a title line in a first color (e.g., royal blue), a two to four line marketing message in a second color (e.g., black), and a Website URL in a third color (e.g., green). Ad format 4300a of FIG. 43A is 120×600 pixels, ad format 4300b of FIG. 43B is 160×600 pixels, ad format 4300c of FIG. 43C is 120×240 pixels, ad format 4300d of FIG. 43D is 180×150 pixels, ad format 4300e of FIG. 43E is 125×125 pixels, ad format 4300f of FIG. 43F is 336×280 pixels, ad format 4300g of FIG. 43G is 300×250 pixels, ad format 4300h of FIG. 43H is 250×250 pixels, ad format 4300i of FIG. 431 is 728×90 pixels, ad format 4300j of FIG. 43J is 468×60 pixels, and ad format 4300k of FIG. 43K is 234×60 pixels. Other ad formats, not shown, having other dimensions (e.g., 120×400 pixels, 200×200 pixels, 420×200 pixels, 420×120 pixels, etc.) are possible.

Naturally, other ad formats are possible. Such ad formats may include one or more of text elements, graphical elements, line segment elements, etc. Similarly, other graphical elements are possible, as are other border designs. One or more of the elements may be associated with the brand of the content-relevant ad server that provided the ads. When it is desired to provide more prominent branding, it may be desirable to place branding elements higher and/or more to the left, since that is the way people read in the U.S., or to locate such branding based on how people read.

A minimum level of branding might be an ad format with “Ads by Google” text, with no brand colors or graphical elements. An intermediate level of branding might be an ad format with “Ads by Google” text and a box surrounding the ads, where the segments of the box are provided in colors associated with the Google brand. Another intermediate level of branding might be an ad format with “Ads by Google” text and a graphical element associated with the Google brand. An high level of branding might be an ad format with “Ads by Google” text, a box surrounding the ads, where the segments of the box are provided in colors associated with the Google brand and a graphical element associated with the Google brand. Another example of a high level of branding might be an ad format with “Ads by Google” text and large graphical elements associated with the Google brand. Naturally, a wide number of branding levels employing various branding elements is possible.

Further, some ad formats, such as those 1000-1900 of FIGS. 10-19, respectively, may include a greater number of ads than other ad formats, such as those 2500-3500 of FIGS. 25-35, respectively. Note also that the individual ads in ad formats 1000-1900 are separated with line segments while the individual ads in ad formats 2500-3500 are not separated.

In embodiments in which publishers have selected, or can select, custom colors for ads to be provided on their Web page, such color selections may be considered in how ads are provided. For example, if an existing publisher has specified customer colors, such a publisher may be notified of the new Google brand color formats. Such a publisher may then log onto the content-relevant ad serving system and opt-into having their current custom color replaced by the new Google brand color formats (e.g., on high performance Web pages). The publisher can select one or more Google ad formats, or even all Google brand color formats. If more than one format is selected, they may be randomly rotated on high performance Web pages. If the publisher does not opt-in, then there is no change to their format. Publishers may be offered incentives, such as a larger share of ad revenue, to opt-into having their current custom color replaced by the new Google brand color formats on high performance Web pages.

If, on the other hand, an existing or new publisher does not have custom colors, such a publisher may be notified of the new Google brand color formats. When such a publisher logs onto the content-relevant ad delivery system, it may be provided with a time period (e.g., two weeks notice) in which to opt-out (in which case the generic Google format of no color customization is not replaced by the new Google brand color formats on high performance pages only). If the publisher does not opt-out within the specified time period, the new Google brand color formats will replace the standard Google format with no color customization (e.g., on high performance pages only). As Google adds more Google brand color formats, a publisher can login and change their selections. The publisher can select one or more Google ad formats, or even all Google brand color formats. If more than one format is selected, they may be randomly rotated on high performance Web pages. Publishers may be offered incentives, such as a larger share of ad revenue, to opt-into having their current custom color replaced by the new Google brand color formats on high performance Web pages.

Similarly, a publisher may be notified of versions of an ad delivery system that change a number of ads served using some factor that may affect end user perception of the ads. For example, a publisher may log onto the content-relevant ad delivery system and configure up to N (e.g., three) new creatives to place in up to N ad slots on a single Web page. The publisher may then place new creative on Web page. That is, the publisher can place multiple ad creatives on the same Webpage. This allows the content-relevant ad delivery system to serve more ads when it is appropriate. The publisher may optionally configure the background color and/or alternative ads to be used when the slot is not filled with ads. In some embodiments, the publisher may be provided with the ability to control how many ads to show, and/or the performance (e.g., selection rate) threshold controlling the number of ads to be rendered.

4.3.7 Alternatives and Refinements

Although some of the foregoing embodiments controlled a number of ads and/or branding, factors affecting end user perceptions of ad quality may also be used to select an ad spot in which to show ads. For example, if the end user perception of the quality of the ads is expected to be bad, the ads can be shown in less prominent ad spots (e.g., a “skyscraper” spot in side margin rather that “leader-board” spot at top).

Although some of the foregoing embodiments discussed scoring a document, sets of documents can be scored. The set of documents may be documents belonging to one Website or one publisher for example. Note that although some of the exemplary embodiments were described in the context of publishers of content-based Web pages, the present invention may be used with other types of publishers, such as search engine Websites generating search result page views for example.

In some of the foregoing embodiments, it was assumed that there would be enough data to determine a document score. However, it may be the case that there won't be enough data to compute a score (or a score with a desired degree of confidence) for all documents. In at least some embodiments consistent with the present invention, a document score can be determined using data from “related” and/or “similar” documents. For example, if a document D does not have enough scores with high confidence, additional data is needed. A good source of such additional data would be to look at “related” and/or “similar” documents. As one example, a document similarity tree may be generated as follows. In a bottom-up process, a node for each document is created. Then at every step, two parentless nodes that are most similar to each other (using some similarity score, like similarity of the set of advertisers that they serve) are found and associated as sibling nodes under a new parent. Once the document similarity tree is generated, if a document D does not have enough data to compute a score S(D), D's parent D1 is found. Some data (e.g., sales, selections) of the parent D1 is set to be the sum of the data for all documents under D1. A score for the parent document S(A,D1) can be determined from the imputed data (i.e., data of its descendants). In a first alternative (e.g., if there is enough data) the new score of the document S(D) can be set to some mix of the score of the parent document S(D1) and the original score of the document S(D). In a second alternative (e.g., if there is not enough data), parent document D1's parent (D2) can be found, and the merging process can be continued. In yet another alternative, the score of the document S(D) can simply inherit the score of its parent S(D1).

In at least some embodiments consistent with the present invention, the publisher may be allowed to control how many ads to show, or to set some performance (e.g., selection rate) threshold for increasing or reducing the number of ads.

Although most of the embodiments discussed above concerned Web page documents, the present invention may be used in the context of other types of documents, such as for ads shown while rendering email, ads shown in the email body via a personal email, a newsletter or a group mailing list, ads shown in document readers like Word or Adobe Acrobat, etc. If the document and/or ads include audio components, the branding may include tones, jingles, sound effects, etc., used to convey source or quality of the ads. Similarly, if the document and/or ads include video components, the branding may include a video sequence used to convey source or quality of the ads.

For publishers receiving ads via an xml datafeed, the number of ads returned could be expanded and a parameter denoting if the ad format branding type should be modified, could be passed to the publisher's server so that it would then render the ads in the appropriate format.

### 4.4 ILLUSTRATIVE EXAMPLES

In the following examples, a document is a Web page and the document score is a selection rate associated with the Web page. A first Web page is considered to be a “high performance” Web page having a selection rate of >0.20. A second Web page is considered to be a “low performance” Web page with a selection rate of <0.20.

For the high performance Web page, it is assumed that the Web page loads and all available ad slots (e.g. leader-board on top, skyscraper on right hand side, and ad banner on bottom) are filled with ads. Each slot includes a strong branding format. (e.g., Google brand colors, if configured, Google trademark icon and if configured, Google brand colors, etc.). If there are no relevant ads found, or if the Webpage is determined to be negative (i.e., concerning negative topics such as murder, suicide, war, tragedy, etc.), then public service ads (PSAs) fill only the top slot, while the others disappear or convert into publisher specified alternative ads (if the publisher has configured fallback ads). Image ads may replace any text ad slot. In at least some embodiments, different amounts of shading, different colors, and/or different visual cues may be used to distinguish normally targeted ads from public service ads, or publisher provided ads.

For the low performance Web page, it is assumed that the Web page loads and only one of the ad slots (e.g. leader-board on top) is filled with ads. Image ads may replace the first text ad slot. Other ad slots on the Web page (e.g. skyscraper on right hand side, and ad banner on bottom) either disappear (blank background), or convert into publisher specified alternative ads (if the publisher has configured fallback ads). The format displayed includes Google attribution, but less prominently (e.g., the Google trademark icon is not shown). If Google does not have the content of the page, or ads to show, or the page is determined to be negative, then PSAs show on only the top slot and the other slots either disappear (blank background) or convert into publisher specified alternative ads (if the publisher has configured fallback ads).

### 4.5 CONCLUSIONS

As can be appreciated from the foregoing, the present invention is advantageous in that it allows high quality ad delivery systems to protect their brand image and enhance the perceived quality of their ads by end users.

What is claimed is:

1. A method comprising:
a) accepting information affecting end user perception of ad quality; and
b) controlling a number of ads to be rendered with a document using the accepted information.

2. The method of claim 1 wherein the information affecting end user perception of ad quality includes a predetermined document score.

3. The method of claim 1 wherein the information affecting end user perception of ad quality is document dependent information.

4. The method of claim 1 wherein the information affecting end user perception of ad quality includes a selection rate associated with the document.

5. The method of claim 1 wherein the information affecting end user perception of ad quality includes a conversion rate associated with the document.

6. The method of claim 1 wherein the act of controlling a number of ads includes determining a number of ads, or adjusting a provided number of ads.

7. The method of claim 1 wherein the information affecting end user perception of ad quality includes performance information of at least one ad of a set of ads to be rendered with the document.

8. The method of claim 1 wherein the information affecting end user perception of ad quality includes a degree of similarity between at least one of the ads and the document.

9. The method of claim 1 wherein the information affecting end user perception of ad quality includes a relevancy score of an ad to content of the document.

10. The method of claim 9 wherein the information affecting end user perception of ad quality further includes a confidence level in the relevancy score.

11. The method of claim 1 wherein the information affecting end user perception of ad quality includes a type of keyword targeting used in determining relevant ads.

12. The method of claim 1 wherein the information affecting end user perception of ad quality includes user behavior.

13. The method of claim 1 wherein if the information affecting end user perception of ad quality indicates that one or more ads will be perceived as being of poor quality, the act of controlling a number of ads provides less ads than normal.

14. The method of claim 1 wherein if the information affecting end user perception of ad quality indicates that one or more ads will be perceived as being of good quality, the act of controlling a number of ads provides more ads than normal.

15. A method comprising:
a) accepting information affecting end user perception of ad quality; and
b) controlling branding elements associated with ads to be rendered with a document using the accepted information.

16. The method of claim 15 wherein the information affecting end user perception of ad quality includes a predetermined document score.

17. The method of claim 15 wherein the information affecting end user perception of ad quality is document dependent information.

18. The method of claim 15 wherein the information affecting end user perception of ad quality includes a selection rate associated with the document.

19. The method of claim 15 wherein the information affecting end user perception of ad quality includes a conversion rate associated with the document.

20. The method of claim 15 wherein the act of controlling branding elements includes at least one of (A) controlling the application of brand colors to an ad format, and (B) controlling the application of brand graphical elements to the ad format.

21. The method of claim 15 wherein the information affecting end user perception of ad quality includes performance information of at least one ad of a set of ads to be rendered with the document.

22. The method of claim 15 wherein the information affecting end user perception of ad quality includes a degree of similarity between at least one of the ads and the document.

23. The method of claim 15 wherein the information affecting end user perception of ad quality includes a relevancy score of an ad to content of the document.

24. The method of claim 23 wherein the information affecting end user perception of ad quality further includes a confidence level in the relevancy score.

25. The method of claim 15 wherein the information affecting end user perception of ad quality includes a type of keyword targeting used in determining relevant ads.

26. The method of claim 15 wherein the information affecting end user perception of ad quality includes user behavior.

27. The method of claim 15 wherein if the information affecting end user perception of ad quality indicates that one or more ads will be perceived as being of poor quality, the act of controlling branding selects an ad format without brand colors.

28. The method of claim 15 wherein if the information affecting end user perception of ad quality indicates that one or more ads will be perceived as being of poor quality, the act of controlling branding selects an ad format without brand graphical elements.

29. The method of claim 15 wherein if the information affecting end user perception of ad quality indicates that one or more ads will be perceived as being of good quality, the act of controlling branding selects an ad format including brand colors.

30. The method of claim 15 wherein if the information affecting end user perception of ad quality indicates that one or more ads will be perceived as being of good quality, the act of controlling branding selects an ad format including brand graphical elements.

31. Apparatus comprising:
a) an input for accepting information affecting end user perception of ad quality; and
b) means for controlling a number of ads to be rendered with a document using the accepted information.

32. The apparatus of claim 31 wherein the information affecting end user perception of ad quality includes a predetermined document score.

33. The apparatus of claim 31 wherein the information affecting end user perception of ad quality is document dependent information.

34. The apparatus of claim 31 wherein the information affecting end user perception of ad quality includes a selection rate associated with the document.

35. The apparatus of claim 31 wherein the information affecting end user perception of ad quality includes a conversion rate associated with the document.

36. The apparatus of claim 31 wherein the means for controlling a number of ads include means for determining a number of ads, or means for adjusting a provided number of ads.

37. The apparatus of claim 31 wherein the information affecting end user perception of ad quality includes performance information of at least one ad of a set of ads to be rendered with the document.

38. The apparatus of claim 31 wherein the information affecting end user perception of ad quality includes a degree of similarity between at least one of the ads and the document.

39. The apparatus of claim 31 wherein the information affecting end user perception of ad quality includes a relevancy score of an ad to content of the document.

10. The apparatus of claim 9 wherein the information affecting end user perception of ad quality further includes a confidence level in the relevancy score.

41. The apparatus of claim 31 wherein the information affecting end user perception of ad quality includes a type of keyword targeting used in determining relevant ads.

42. The apparatus of claim 31 wherein the information affecting end user perception of ad quality includes user behavior.

43. The apparatus of claim 31 wherein if the information affecting end user perception of ad quality indicates that one or more ads will be perceived as being of poor quality, the means for controlling a number of ads provide less ads than normal.

44. The apparatus of claim 31 wherein if the information affecting end user perception of ad quality indicates that one or more ads will be perceived as being of good quality, the means for controlling a number of ads provide more ads than normal.

45. Apparatus comprising:
a) an input for accepting information affecting end user perception of ad quality; and
b) means for controlling branding elements associated with ads to be rendered with a document using the accepted information.

46. The apparatus of claim 45 wherein the information affecting end user perception of ad quality includes a predetermined document score.

47. The apparatus of claim 45 wherein the information affecting end user perception of ad quality is document dependent information.

48. The apparatus of claim 45 wherein the information affecting end user perception of ad quality includes a selection rate associated with the document.

49. The apparatus of claim 45 wherein the information affecting end user perception of ad quality includes a conversion rate associated with the document.

50. The apparatus of claim 45 wherein the means for controlling branding elements includes at least one of (A) means for controlling the application of brand colors to an ad format, and (B) means for controlling the application of brand graphical elements to the ad format.

51. The apparatus of claim 45 wherein the information affecting end user perception of ad quality includes performance information of at least one ad of a set of ads to be rendered with the document.

52. The apparatus of claim 45 wherein the information affecting end user perception of ad quality includes a degree of similarity between at least one of the ads and the document.

53. The apparatus of claim 45 wherein the information affecting end user perception of ad quality includes a relevancy score of an ad to content of the document.

54. The apparatus of claim 53 wherein the information affecting end user perception of ad quality further includes a confidence level in the relevancy score.

55. The apparatus of claim 45 wherein the information affecting end user perception of ad quality includes a type of keyword targeting used in determining relevant ads.

56. The apparatus of claim 45 wherein the information affecting end user perception of ad quality includes user behavior.

57. The apparatus of claim 45 wherein if the information affecting end user perception of ad quality indicates that one or more ads will be perceived as being of poor quality, the means for controlling branding select an ad format without brand colors.

58. The apparatus of claim 45 wherein if the information affecting end user perception of ad quality indicates that one or more ads will be perceived as being of poor quality, the means for controlling branding select an ad format without brand graphical elements.

59. The apparatus of claim 45 wherein if the information affecting end user perception of ad quality indicates that one or more ads will be perceived as being of good quality, the means for controlling branding select an ad format including brand colors.

60. The apparatus of claim 45 wherein if the information affecting end user perception of ad quality indicates that one or more ads will be perceived as being of good quality, the means for controlling branding select an ad format including brand graphical elements.

61. A method comprising:
a) accepting information affecting end user perception of ad quality; and
b) controlling a prominence with which the ads are to be rendered with a document using the accepted information.

62. The method of claim 61 wherein the information affecting end user perception of ad quality includes a predetermined document score.

63. The method of claim 61 wherein the information affecting end user perception of ad quality is document dependent information.

64. The method of claim 61 wherein the information affecting end user perception of ad quality includes a selection rate associated with the document.

65. The method of claim 61 wherein the information affecting end user perception of ad quality includes a conversion rate associated with the document.

66. The method of claim 61 wherein the act controlling a prominence with which the ads are to be rendered includes controlling which of a plurality of ad spots the ads are to be rendered in.

67. The method of claim 61 wherein the information affecting end user perception of ad quality includes performance information of at least one ad of a set of ads to be rendered with the document.

68. The method of claim 61 wherein the information affecting end user perception of ad quality includes a degree of similarity between at least one of the ads and the document.

69. The method of claim 61 wherein the information affecting end user perception of ad quality includes a relevancy score of an ad to content of the document.

70. The method of claim 61 wherein the information affecting end user perception of ad quality further includes a confidence level in the relevancy score.

71. The method of claim 61 wherein the information affecting end user perception of ad quality includes a type of keyword targeting used in determining relevant ads.

72. Apparatus comprising:
a) an input for accepting information affecting end user perception of ad quality; and
b) means for controlling a prominence with which the ads are to be rendered with a document using the accepted information.

73. The apparatus of claim 72 wherein the information affecting end user perception of ad quality includes a predetermined document score.

74. The apparatus of claim 72 wherein the information affecting end user perception of ad quality is document dependent information.

75. The apparatus of claim 72 wherein the information affecting end user perception of ad quality includes a selection rate associated with the document.

76. The apparatus of claim 72 wherein the information affecting end user perception of ad quality includes a conversion rate associated with the document.

77. The apparatus of claim 72 wherein the means for controlling a prominence with which the ads are to be rendered include means for controlling which of a plurality of ad spots the ads are to be rendered in.

78. The apparatus of claim 72 wherein the information affecting end user perception of ad quality includes performance information of at least one ad of a set of ads to be rendered with the document.

79. The apparatus of claim 72 wherein the information affecting end user perception of ad quality includes a degree of similarity between at least one of the ads and the document.

80. The apparatus of claim 72 wherein the information affecting end user perception of ad quality includes a relevancy score of an ad to content of the document.

81. The apparatus of claim 72 wherein the information affecting end user perception of ad quality further includes a confidence level in the relevancy score.

82. The apparatus of claim 72 wherein the information affecting end user perception of ad quality includes a type of keyword targeting used in determining relevant ads.
